(19) United States
(12) Patent Application Publication
(10) Pub. No.: US 2008/0159310 A1
(43) Pub. Date: Jul. 3, 2008

(54) Packet Control Apparatus, Authentication Server, and Wireless Communication System

(76) Inventors: Satoshi Senga, Saitama (JP); Hidenori Ishii, Tokyo (JP); Hiroshi Ishida, Kanagawa (JP); Takeshi Kanazawa, Kanagawa (JP)

Correspondence Address: PEARNE & GORDON LLP, 1801 EAST 9TH STREET, SUITE 1200, CLEVELAND, OH, 44114-3108, US

(21) Appl. No.: 11/814,322

(22) PCT Filed: Jan. 6, 2006
(86) PCT No.: PCT/JP2006/300089

§ 371 Date: Aug. 6, 2007

(30) Foreign Application Priority Data
Jan. 21, 2005 (JP) 2005-014021

(51) Int. Cl. H04L 12/66; G06F 7/04

(52) U.S. Cl. 370/401; 726/3

(57) ABSTRACT

An object of the invention is to shorten the switching time from a first network to a second network.

A packet control apparatus 106 includes 3G authentication server communication means 201 for receiving a switch notification of a terminal switched from a mobile communication network to a WLAN network by conducting communications with a 3G authentication server 108 for performing network authentication processing; terminal address determination means 202 for determining an address that can be used in the WLAN network; and WLAN switch management means 204 for assigning the address determined by the terminal address determination means 202 to the terminal determined by making a comparison between the authentication information of the terminal contained in the switch notification and the authentication information contained in a table for managing information concerning terminals that can access the mobile communication network and the WLAN network and switching the destination of a packet via the mobile communication network to the WLAN network.

### TECHNICAL FIELD

This invention relates to a hand over technology of continuing communications in an interworking system of different types of networks.

### BACKGROUND ART

In recent years, a system of interworking a mobile telephone has been examined to interwork communications in between a wide area and a WLAN service for enabling high-speed data communications in a narrow area and make them complement each other. For the interwork system, an architecture for implementing a scenario where terminals access packet service of a mobile communication network via WLAN or the like is standardized in 3GPP (3rd Generation Partnership Project). The requirements are described in 3GPP TS (Technical Specification) 22.234, the architecture is described in TS23.234, and an authentication system is described in TS33.234.

FIG. 9 is a block diagram of the configuration of an interwork system constructed in a prior art. A terminal 901 has packet access means of both mobile communication network and WLAN. The terminal 901 corresponds to UE (User Equipment) in the 3GPP standard.

A base station apparatus 905 inter-converts a wireless signal from the terminal 901 into a wired signal for transmission in the mobile communication network. The base station apparatus 905 corresponds to Node B in the 3GPP standard. A WLAN access network 902 is a packet network based on IP (Internet Protocol), etc. The WLAN access network 902 converts a WLAN wireless signal into a packet signal on a wire network. The WLAN access network 902 also performs address assignment operation as a DHCP server. The WLAN access network 902 corresponds to WLAN AN (Access Network) in the 3GPP standard.

A radio network control apparatus 906 is connected to the base station apparatus 905. The radio network control apparatus 906 performs wireless-related terminal control and transmits control data and user data in the mobile communication network. The radio network control apparatus 906 corresponds to RNC (Radio Network Controller) in the 3GPP standard. A WLAN gateway 903 is connected to the WLAN access network 902. The WLAN gateway 903 transfers WLAN control data and user data to and from the WLAN access network 902. The WLAN gateway 903 corresponds to WAG (Wireless Access Gateway) in the 3GPP standard.

A packet control apparatus 907 is connected to the radio network control apparatus 906. The packet control apparatus 907 performs packet transmission control processing in the mobile communication network and state management of the terminal 901 involved in packet transmission. The packet control apparatus 907 corresponds to SGSN (Serving GPRS Support Node) in the 3GPP standard. A mobile network packet gateway 908 is connected to the packet control apparatus 907. The mobile network packet gateway 908 relays packet data from the mobile communication network to public packet network(Internet). The mobile network packet gateway 908 corresponds to GGSN (Gateway GPRS Support Node) in the 3GPP standard.

A packet data gateway 904 is connected to the WLAN gateway 903. The packet data gateway 904 relays packet data to a public packet network packet 912. The packet data gateway 904 corresponds to PDG (Packet Data Gateway) in the 3GPP standard. A 3G authentication server 909 is connected to the WLAN access network 902. The 3G authentication server 909 accepts authentication data from the terminal 901. The 3G authentication server 909 corresponds to AAA Server in the 3GPP standard.

User information storage 910 is connected to the packet control apparatus 907, the mobile network packet gateway 908, and the 3G authentication server 909. In the user information storage 910 information of service which a user contracts with a communication operator of a mobile communication network or a WLAN.

The case where the user moves from the coverage area of the mobile communication network to WLAN when making packet access using the terminal 901 that can access both the mobile communication network and WLAN in the system is assumed. In this case, to continue the communications, a home address management apparatus 911 becomes necessary so that movement transparency from an opposite node 913 can be ensured.

The opposite node 913 is a party with which the terminal 901 conducts packet communications. For example, a server, etc., installed on the Internet is contained in the opposite node 913. The home address management apparatus 911 relays data transmission of the opposite node 913 and changes the data destination in response to the location to which the terminal 901 moves. The home address management apparatus 911 conducts position management of the terminal 901 according to mobile IP and registers the location to which the terminal 901 moves.

The case where packet communications are conducted via the mobile communication network between the terminal 901 and the opposite node 913 is assumed. In this case, a method of switching to communications via WLAN when the terminal 901 enters the WLAN area will be explained with FIG. 10.

IP packets of the terminal 901 arrives at the opposite node 913 via the nodes of the mobile communication network and the home address management apparatus 911. An IP address of the terminal 901 in the mobile communication network is assigned by the mobile network packet gateway 908. This IP address is called remote IP address.

The home address management apparatus 911 manages a pair of the home IP address of the address in the home network of the terminal 901 and the remote IP address of the terminal 901. The home address management apparatus 911 encapsules the home IP address of the terminal 901 output by the opposite node 913 for transmission. Conversely, IP packet from the terminal 901 is encapsuled for transmission like a packet in the opposite direction.

In the mobile communication network, an IP tunnel is created between nodes and an IP packet is encapsuled for transmission. GTP (GPRS Tunneling Protocol) is used between the mobile network packet gateway 908 and the packet control apparatus 907 and between the packet control apparatus 907 and the radio network control apparatus 906. The radio network control apparatus 906 appropriately converts the IP packet into a logical channel or a transport channel and transmits it to the base station apparatus 905 using IP transport. The base station apparatus 905 converts the IP packet into a physical channel of W-CDMA and conducts communications with the terminal 901.

When entering the WLAN area (1001), the terminal 901 detects WLAN radio wave. Authentication processing for the terminal 901 to use an access point in the WLAN access network 902 (1002) is performed.

Then, the WLAN access network 902 and the 3G authentication server 909 conduct user authentication processing. At this time, the 3G authentication server 909 performs authentication for the user information storage 910 to check to see if the user is an interwork service subscriber (1003).

After the termination of the authentication, the DHCP server in the WLAN access network 902 assigns an IP address for conducting IP communications to the terminal 901 (1004). This assigned IP address is called local IP address.

Then, a PDG address solution request of the packet data gateway 904 as a gateway for conducting IP packet communications with the opposite node 913 using the WLAN in the mobile communication network is made (1005) by the terminal 901. An IP address of the terminal 901 using the WLAN in the mobile communication network is assigned by the packet data gateway 904 (1006). This IP address is an IP address having a role equal to the remote IP address assigned when IP packet communications are conducted via the mobile network packet gateway 908. The IP address is an address for uniquely identifying the terminal 901 in the mobile communication network.

In a tunnel creation request (1007) via the WLAN, the terminal 901 creates an IP tunnel with the packet data gateway 904 determined in the PDG address solution request (1005). At the time, the packet data gateway 904 relays the 3G authentication server 909 and performs authentication completion confirmation processing (1008) for confirming that the terminal 901 has been authenticated in the interwork service.

Next, in filter setting (1009), the packet data gateway 904 and the WLAN gateway 903 set a packet transmission filter. The applied filter is determined by the packet data gateway 904. The WLAN gateway 903 applies the transmission filter obtained from the packet data gateway 904. After the filter is set, the tunnel attributes are exchanged between the terminal 901 and the packet data gateway 904 and a tunnel therebetween is created (1010).

When the tunnel is created, the terminal 901 registers the remote IP address in the home address management apparatus 911 through the packet data gateway 904 (1011). When the remote IP address is registered the home address management apparatus 911 changes the destination of a packet from the opposite node 913 to the terminal 901 corresponding to the new remote IP address.

When the connection in the WLAN is thus established (1012), the terminal 901 terminates the transmission in the mobile communication network used before entering the WLAN area. This processing is performed by issuing 3G termination processing (1013) to the packet control apparatus 907.

Non-patent document 1: TS22.234 ver. 6.1.0 “Requirements on 3GPP system to Wireless Local Area Network (WLAN) interworking” Jun. 14, 2004 (Chapter 5) http://www.3gpp.org/ftp/Specs/html-info/22234.htm

Non-patent document 2: TS23.234 Ver. 6.1.0 “3GPP system to Wireless Local Area Network (WLAN) interworking” Jun. 22, 2004 (Chapter 6) http://www.3gpp.org/ftp/Specs/html-info/23234.htm

Non-patent document 3: TS33.234 Ver. 6.0.0 “Wireless Local Area Network (WLAN) interworking security” Jun. 15, 2004 (Chapter 6) http://www.3gpp.org/ftp/Specs/html-info/33234.htm

### DISCLOSURE OF THE INVENTION

### Problems to be Solved by the Invention

When the terminal moves from the area in the mobile communication network to the WLAN area while thus conducting communications, authentication processing in the WLAN area and mutual authentication of the mobile communication network and the WLAN need to be performed. Thus, a break occurs in real time communications of a video conference, video distribution, etc., using the Internet.

In the interwork system with WLAN defined in 3GPP, three types of processing are required after the mutual authentication, namely, PDG address solution (1005), re-authentication processing at the tunnel creation time in WLAN traffic transmission (1008), and registration of the remote IP address in the home address management apparatus (1011). Since these types of processing occur, time is required until completion of interwork and a break at the real time communication time occurs.

It is therefore an object of the invention to provide a packet control apparatus, an authentication server, and a wireless communication system that can shorten the switching time from a first network to a second network.

### Means for Solving the Problems

A packet control apparatus of the invention includes an authentication server communication section for receiving a switch notification of a terminal switched from a first network to a second network by conducting communications with an authentication server for performing network authentication processing; an address determination section for determining an address that can be used in the second network; and a switch management section for assigning the address determined by the address determination section to the terminal determined by making a comparison between the authentication information of the terminal contained in the switch notification and the authentication information contained in a table for managing information concerning terminals that can access the first and second networks and switching the destination of a packet via the first network to the second network.

According to the configuration, the address determined by the address determination section is assigned to the terminal determined by making a comparison between the authentication information of the terminal contained in the switch notification and the authentication information contained in the table for managing information concerning terminals that can access the first and second networks and the destination of a packet via the first network is switched to the second network, whereby the time required for address solution can be shortened, so that the switching time from the first network to the second network can be shortened.

In the packet control apparatus of the invention, upon reception of the switch notification, the switch management section updates information indicating the authentication result of the first network contained in the table to already authenticated.

According to the configuration, upon reception of the switch notification, the information indicating the authentication result of the first network contained in the table is updated to already authenticated, whereby re-authentication processing can be shortened.

In the packet control apparatus of the invention, the switch management section manages the IP address of the terminal assigned in the second network according to information indicating the IP address in the second network, contained in the table.

According to the configuration, the IP address of the terminal assigned in the second network is managed according to the table, whereby if the network is switched to the second network, the IP address does not change as for the remote IP address and thus the need for registering the remote IP address in a home address management apparatus formerly required is eliminated.

In the packet control apparatus of the invention, the switch management section makes filter setting of a transmission packet via the first network with the above-mentioned gateway based on information of subscription service contained in the switch notification.

According to the configuration, filter setting of a transmission packet via the first network is made with the above-mentioned gateway based on the information of subscription service contained in the switch notification, whereby transmission control responsive to the subscription service can be performed.

An authentication server of the invention is an authentication server for performing network authentication processing, and includes means for issuing a switch notification of a terminal switched from a first network to a second network; and means for transmitting the switch notification to the packet control apparatus as claimed in claim 1.

According to the configuration, the switch notification storing user's authentication information is sent to the packet control apparatus based on the authentication processing, whereby information to switch packet communications via the first network to those via the second network can be passed to the packet control apparatus.

Further, a wireless communication system of the invention includes the control apparatus of the invention and the authentication server of the invention.

### ADVANTAGES OF THE INVENTION

According to the invention, the address determined by the address determination section is assigned to the terminal determined by making a comparison between the authentication information of the terminal contained in the switch notification and the authentication information contained in the table for managing information concerning terminals that can access the first and second networks and the destination of a packet via the first network is switched to the second network, whereby the time required for address solution can be shortened, so that the switching time from the first network to the second network can be shortened.

### BRIEF DESCRIPTION OF THE DRAWINGS

FIG. 1 is a diagram to show an architecture of an interwork system of a mobile communication network and a WLAN network according to a first embodiment;

FIG. 2 is a diagram to show the configuration of a packet control apparatus according to the first embodiment;

FIG. 3 is a diagram to show the configuration of a 3G authentication server according to the first embodiment;

FIG. 4 is an operation sequence chart to show an interwork flow of the mobile communication network and the WLAN network according to the first embodiment;

FIG. 5 is a drawing to show protocol stacks in packet communications using the mobile communication network according to the first embodiment;

FIG. 6 is a drawing to show a switch management table according to the first embodiment;

FIG. 7 is a drawing to show an access network switch notification according to the first embodiment;

FIG. 8 is a drawing to show protocol stacks in packet communications using the WLAN network according to the first embodiment;

FIG. 9 is a diagram to show an architecture of an interwork system of a mobile communication network and a WLAN network in a prior art; and

FIG. 10 is an operation sequence chart to show an interwork flow of the mobile communication network and the WLAN network in the prior art.

### DESCRIPTION OF REFERENCE NUMERALS

101 Terminal
102 WLAN access network
103 WLAN gateway
104 Base station apparatus
105 Radio network control apparatusRadio network control apparatus
106 Packet control apparatus
107 Mobile network packet gateway
108 3G authentication server
109 User information storage
110 Public packet network packet
111 Opposite node
201 3G authentication server communication means
202 Terminal address determination means
203 WAG communication means
204 WLAN switch management means
205 GTP-u conversion means
206 GGSN communication means
207 SGSN connection setting means
208 RNC communication means
301 WAG communication means
302 HSS communication means
303 3G authentication management means
304 WLAG communication means
305 SGSN communication means
600 Switch management table
601 User authentication ID
602 3G user identifier
603 GTP-u number
604 Distribution remote IP address
605 Distribution local IP address
606 WLAN authentication
700 Access network switch notification
701 User identifier
702 3G user identifier
703 Connect-to ISP
704 Subscription service
901 Terminal
902 WLAN access network
903 WLAN gateway
904 Packet data gateway
905 Base station apparatus
906 Radio network control apparatus
907 Packet control apparatus
908 Mobile network packet gateway
909 3G authentication server
910 User information storage
911 Home address management apparatus
912 Public packet network packet
913 Opposite node

### BEST MODE FOR CARRYING OUT THE INVENTION

A packet control apparatus and a wireless communication system wherein a mobile communication network and WLAN interwork according to an embodiment of the invention will be explained with reference to the accompanying drawings.

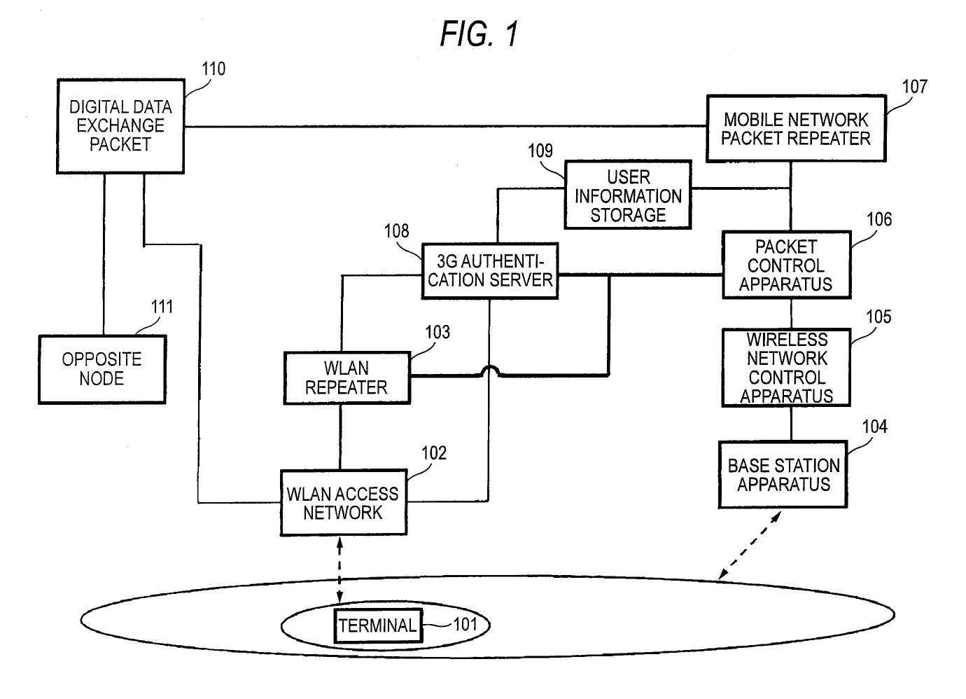

FIG. 1 is a schematic block diagram to describe the configuration of an architecture of a wireless communication system wherein a mobile communication network and WLAN interwork applied to the embodiment of the invention. A terminal 101 has packet access means of both the mobile communication network and WLAN. The terminal 101 corresponds to UE (User Equipment) in the 3GPP standard.

A base station apparatus 104 inter-converts a wireless signal from the terminal 101 into a wired signal for transmission in the mobile communication network. The base station apparatus 104 corresponds to Node B in the 3GPP standard. A WLAN access network 102 is a packet network based on IP, etc. The WLAN access network 102 converts a WLAN wireless signal into a packet signal on a wire network. It is assumed that the WLAN access network 102 also performs address assignment operation as a DHCP server. The WLAN access network 102 corresponds to WLAN AN in the 3GPP standard.

A radio network control apparatus 105 is connected to the base station apparatus 104 through the IP. The radio network control apparatus 105 performs terminal control in wireless relation and transmits control data and user data in the mobile communication network. The radio network control apparatus 105 corresponds to RNC in the 3GPP standard. It may be connected to the base station apparatus 104 using ATM (Asynchronous Transfer Mode). A WLAN gateway 103 is connected to the WLAN access network 102 and a packet control apparatus 106. The WLAN gateway 103 transmits WLAN control data and user data. The WLAN gateway 103 corresponds to WAG in the 3GPP standard.

The packet control apparatus 106 is connected to the radio network control apparatus 105, the WLAN gateway 103, and a 3G authentication server 108. The packet control apparatus 106 corresponds to SGSN in the 3GPP standard. The packet control apparatus 106 and the radio network control apparatus 105 are connected using the IP. The packet control apparatus 106 performs packet transmission control processing and state management of the terminal 101 involved in packet transmission. The packet control apparatus 106 and the radio network control apparatus 105 may be connected using the ATM. The packet control apparatus 106 transfers WLAN control data and user data to and from the WLAN gateway 103. The packet control apparatus 106 exchanges authentication information required for user authentication with the 3G authentication server 108.

A mobile network packet gateway 107 is connected to the packet control apparatus 106 through the IP. The mobile network packet gateway 107 relays packet data from the mobile communication network to a public packet network packet 110. The mobile network packet gateway 107 corresponds to GGSN in the 3GPP standard.

A 3G authentication server 108 is connected to the WLAN access network 102 and the packet control apparatus 106. The 3G authentication server 108 corresponds to AAA Server in the 3GPP standard. The 3G authentication server 108 receives authentication data from the terminal 101 with the WLAN access network 102. The 3G authentication server 108 exchanges authentication information required for user authentication with the packet control apparatus 106.

User information storage 109 is connected to the packet control apparatus 106, the mobile network packet gateway 107, and the 3G authentication server 108. In the user information storage 109 information of service (subscription service information), which a user contracts with a communication operator of a mobile communication network or a WLAN.i

The differences from the prior art example exist in that when the terminal 101 of the user enters the WLAN area from the mobile communication network area while conducting communications, mobile communication network authentication information and WLAN authentication information are exchanged between the packet control apparatus 106 and the 3G authentication server 108, that the packet control apparatus 106 assigns the local IP address of the terminal 101 used in the WLAN access network 102, and that the packet control apparatus 106 rather than home address management apparatus routes packet data by creating a tunnel with the terminal 101 through the WLAN gateway 103.

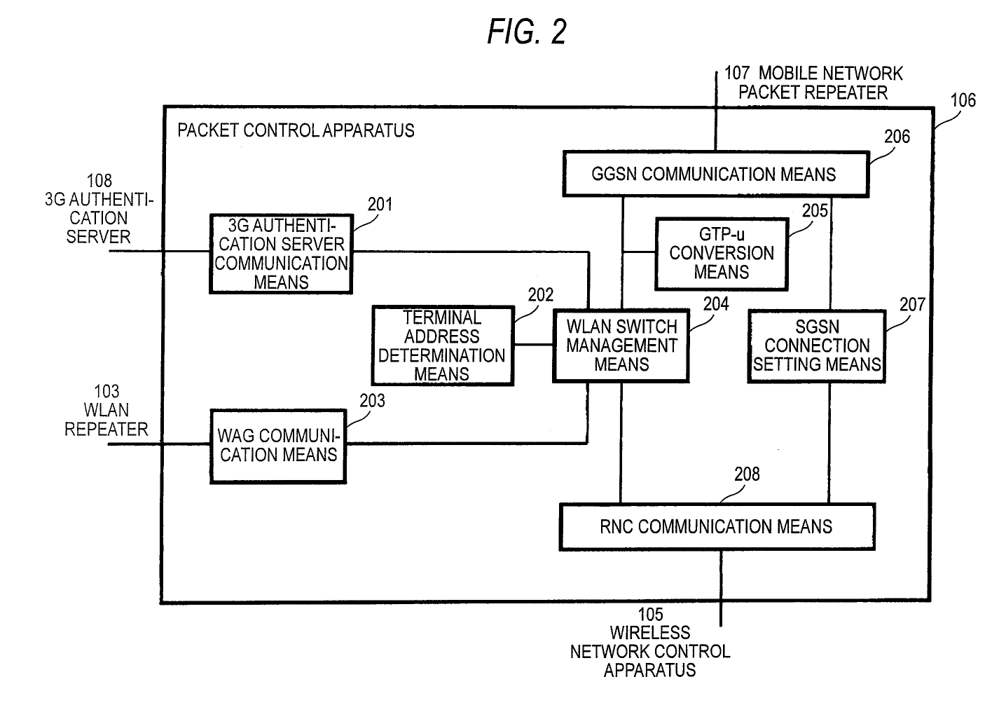

FIG. 2 is a detailed block diagram of the packet control apparatus 106 applied to the embodiment of the invention. As shown in FIG. 2, the packet control apparatus 106 includes a plurality of interfaces and are connected to the 3G authentication server 108, the WLAN gateway 103, the mobile network packet gateway 107, and the radio network control apparatus 105.

3G authentication server communication means 201 exchanges an access network switch notification when the user switches the access network by communicating with the 3G authentication server 108 for performing network authentication processing. The 3G authentication server communication means 201 receives a switch notification of the terminal with the network switched. WAG communication means 203 is means for communicating with the WLAN gateway 103. GGSN communication means 206 is means for communicating with the mobile network packet gateway 107. RNC communication means 208 is means for communicating with the radio network control apparatus 105. SGSN connection setting means 207 performs packet transmission control processing in the mobile communication network and state management of the terminal 101 involved in packet transmission.

WLAN switch management means 204 determines the terminal by making a comparison between authentication information of the terminal contained in the access network switch notification and authentication information contained in a table for managing information concerning terminals that can access the mobile communication network and WLAN. It assigns the address determined by terminal address determination means 202 (described later) to the determined terminal and switches the destination of a packet via the mobile communication network to WLAN. When the 3G authentication server communication means 201 receives a switch notification, the WLAN switch management means 204 assigns the local IP address to the terminal 101, creates a tunnel with the terminal 101, and switches to data transmission using the WLAN so that packet communications used in the mobile communication network can be used in the WLAN.

The terminal address determination means 202 is means for determining the local IP address that can be used in the WLAN area that the terminal 101 enters. The WLAN switch management means 204 assigns the local IP address to the terminal 101.

GTP-u conversion means 205 is means for converting traffic via WLAN from the terminal 101 into GTP used in communications with the mobile network packet gateway 107. The GTP implements a tunneling function for user data transfer in the mobile communication network.

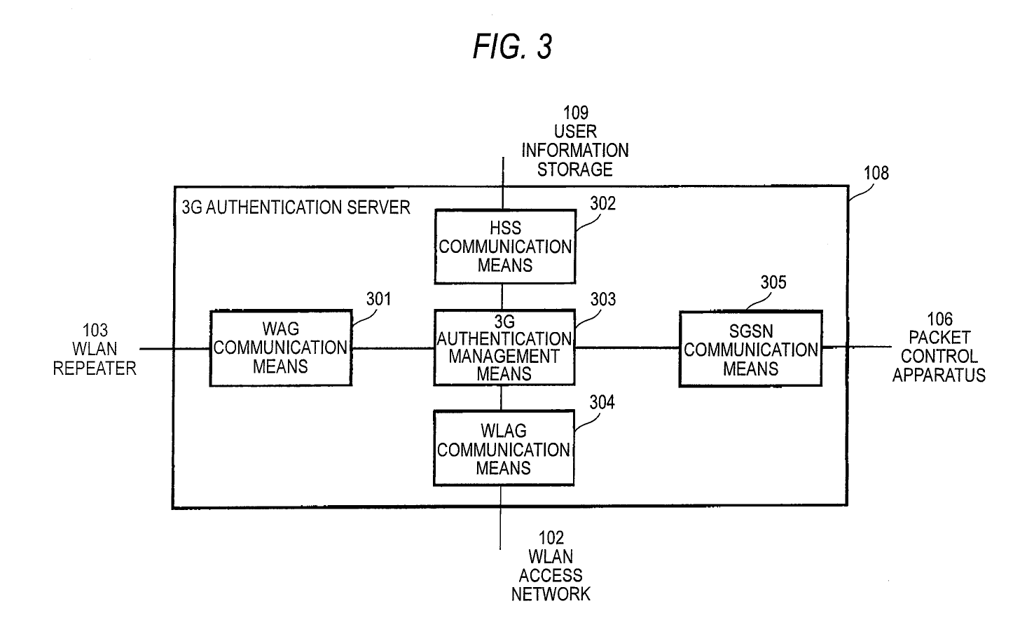

FIG. 3 is a detailed block diagram of the 3G authentication server 108 applied to the embodiment of the invention. The 3G authentication server 108 performs network authentication processing. As shown in FIG. 3, the 3G authentication server 108 includes a plurality of interfaces and are connected to the user information storage 109, the WLAN gateway 103, the packet control apparatus 106, and the WLAN access network 102.

HSS communication means 302 is means for communicating with the user information storage 109. The HSS communication means 302 checks information of service which a user contracts with a communication operator of a mobile communication network or a WLAN. WAG communication means 301 is means for communicating with the WLAN gateway 103. WLAN communication means 304 is means for performing WLAN traffic transmission with the WLAN access network 102. SGSN communication means 305 is means for communicating with the packet control apparatus 106. The SGSN communication means 305 exchanges an access network switch notification when the user switches the access network. That is, the SGSN communication means 305 transmits an access network switch notification to the packet control apparatus 106.

3G authentication management means 303 performs user authentication processing in the mobile communication network and performs user authentication processing in interworking in WLAN with the mobile communication network when the terminal enters the WLAN area. The 3G authentication management means 303 also issues the result as an access network switch notification and passes the notification to the SGSN communication means 305 described above.

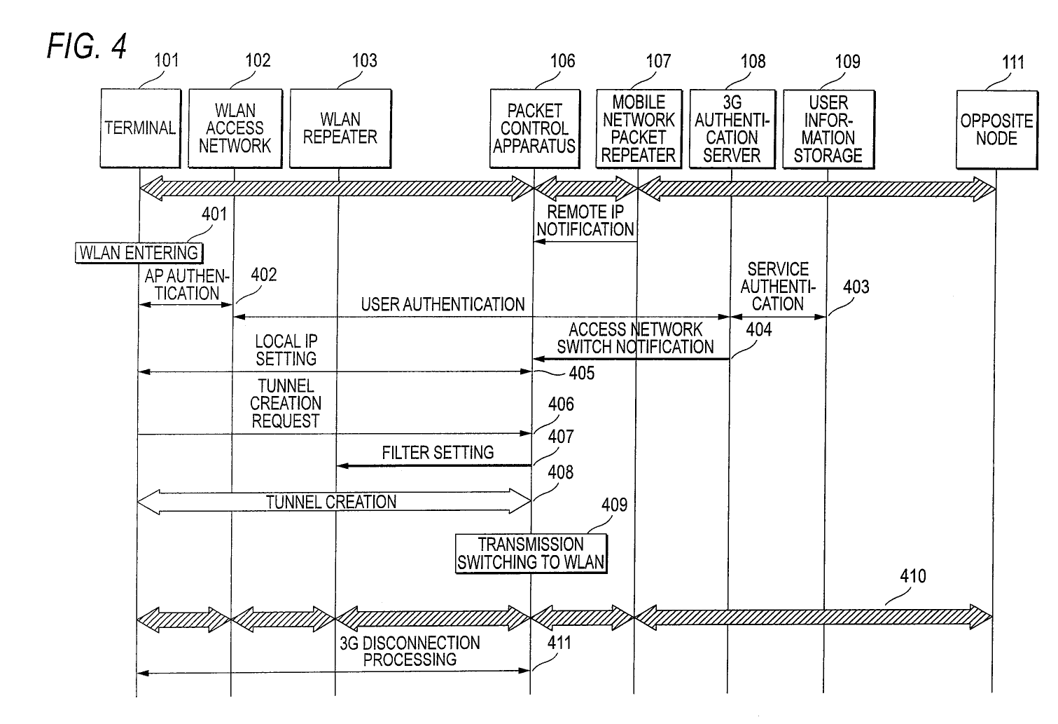

The operation conducted in the embodiment of the invention will be explained. FIG. 4 is an operation sequence chart to show a processing flow of the packet control apparatus 106 for switching traffic of packet communications from the mobile communication network to WLAN traffic when the terminal 101 for conducting packet communications enters a WLAN area from the mobile communication network.

IP packet communications of the terminal 101 using the mobile communication network arrives at the opposite node 111 via the base station apparatus 104, the radio network control apparatus 105, the packet control apparatus 106, and the mobile network packet gateway 107.

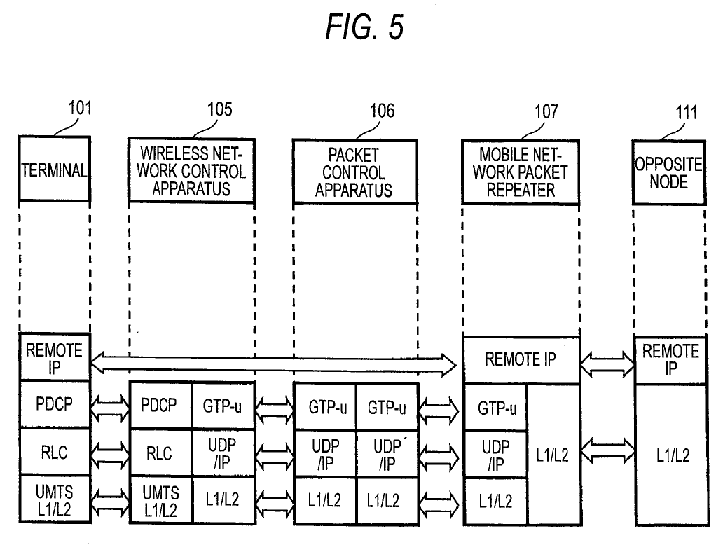

FIG. 5 shows protocol stacks in the packet communications using the mobile communication network. An IP address of the terminal 101 is assigned by the mobile network packet gateway 107. This IP address is an address for enabling the opposite node 111 to uniquely identify the terminal 101 and is the remote IP address in the embodiment.

After the remote IP address of the terminal 101 is assigned by the mobile network packet gateway 107 as initialization, the remote IP address of the terminal 101 is sent to the packet control apparatus 106. The WLAN switch management means 204 in the packet control apparatus 106 retains the remote IP address of the terminal 101 as a switch management table.

In the packet communications in the mobile communication network, an IP tunnel is created between nodes and an IP packet is encapsuled for transmission. GTP is used between the mobile network packet gateway 107 and the packet control apparatus 106 and between the packet control apparatus 106 and the radio network control apparatus 105. The radio network control apparatus 105 appropriately converts the IP packet into a logical channel or a transport channel and transmits it to the base station apparatus 104 using IP transport. The base station apparatus 104 converts the IP packet into a physical channel of W-CDMA and conducts communications with the terminal 101.

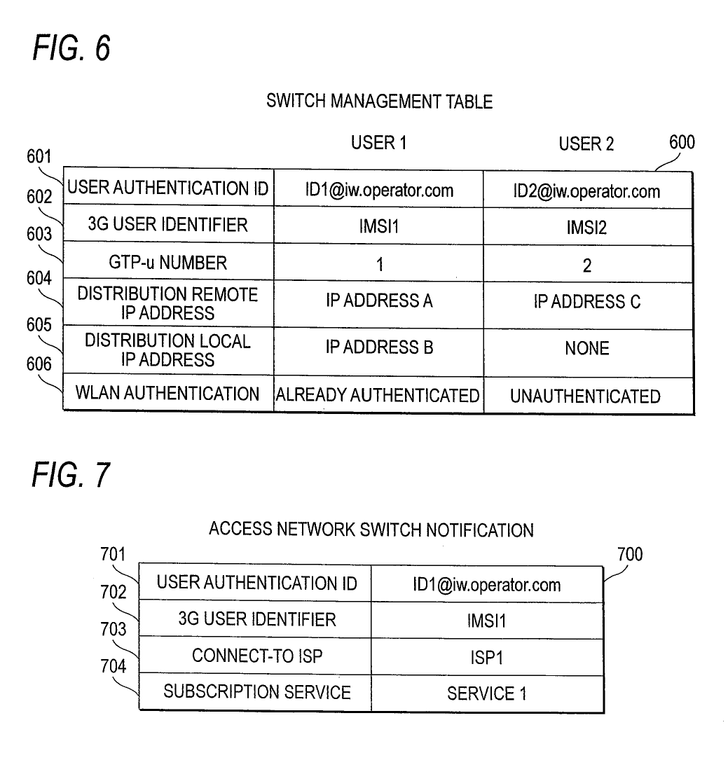

The details of switch management table 600 retained by the WLAN switch management means 204 in the packet control apparatus 106 will be explained with FIG. 6. The switch management table 600 manages each user under six items of user authentication ID 601, 3G user identifier 602, GTP-u number 603, distribution remote IP address 604, distribution local IP address 605, and WLAN authentication 606.

The user authentication ID 601 is an ID required for authentication of the user making an interwork service contract. The 3G user identifier 602 is user identifier IMSI (International Mobile Subscriber Identity) fixedly assigned to the terminal 101 in the mobile communication network. The GTP-u number 603 is the identifier of GTP used in the packet communications of the user in the mobile communication network. The distribution remote IP address 604 is a remote IP address assigned to the terminal 101 by the mobile network packet gateway 107. The distribution local IP address 605 is a local IP address assigned to the terminal 101 by the terminal address determination means 202 of the packet control apparatus 106 for use in a WLAN area. The WLAN authentication 606 is information indicating whether or not WLAN authentication has been conducted when the terminal 101 enters a WLAN area.

When the terminal 101 enters a WLAN area (401), it detects WLAN radio wave. Authentication processing for the terminal 101 to use an access point (AP) is performed in the WLAN access network 102 (402). Then, authentication processing of the user is performed in the WLAN access network 102 and the 3G authentication server 108 (403). At the time, the 3G authentication server 108 authenticates the user as to whether or not the user is an interwork service subscriber for the user information storage 109 (403).

At the termination of the authentication, the 3G authentication management means 303 in the 3G authentication server 108 issues the result as an access network switch notification. The SGSN communication means 305 in the 3G authentication server 108 notifies the packet control apparatus 106 that the terminal 101 enters the WLAN area as an access network switch notification (404).

The details of an access network switch notification 700 will be explained with FIG. 7. The access network switch notification 700 has four items of user authentication ID 701, 3G user identifier 702, connect-to ISP 703, and subscription service 704.

The user authentication ID 701 is an ID required for authentication of the user making an interwork service contract. The 3G user identifier 702 is user identifier IMSI (International Mobile Subscriber Identity) fixedly assigned to the terminal 101 in the mobile communication network. The connect-to ISP 703 is information indicating the Internet service provider for providing the WLAN when the terminal enters the WLAN area. The subscription service 704 is information indicating the service subscribed to by the user as an option in addition to the interwork service. The secure state of a transmission band, etc., can be named as options to the items managed in the access network switch notification 700. When creating a tunnel with the terminal 101, it is made possible for the packet control apparatus 106 to change setting according to the option type.

Upon reception of the access network switch notification 700 from the 3G authentication server 108, the packet control apparatus 106 makes a comparison between the user authentication ID 601 and the 3G user identifier 602 in the switch management table 600 of the WLAN switch management means 204 and the user authentication ID 701 and the 3G user identifier 702 in the access network switch notification 700. As for the user with a match found in the comparison, the WLAN authentication 606 in the switch management table 600 is set to already authenticated.

The IP address to conduct IP communications in the WLAN access network 102 is determined by the terminal address determination means 202 in the packet control apparatus 106. The WLAN switch management means 204 assigns the IP address to the terminal 101 (405). The assigned IP address becomes the local IP address.

After the local IP address is assigned, the terminal 101 sends a tunnel creation request to the packet control apparatus 106 (406). The packet control apparatus 106 references the WLAN authentication 606 in the switch management table 600. If the WLAN authentication 606 is set to already authenticated as a result of the reference, the packet control apparatus 106 sets a packet transmission filter together with the WLAN gateway 103 in filter setting (407)

The applied filter is determined by the packet control apparatus 106 based on the subscription service 704 in the access network switch notification 700. The WLAN gateway 103 applies the transmission filter obtained from the packet control apparatus 106.

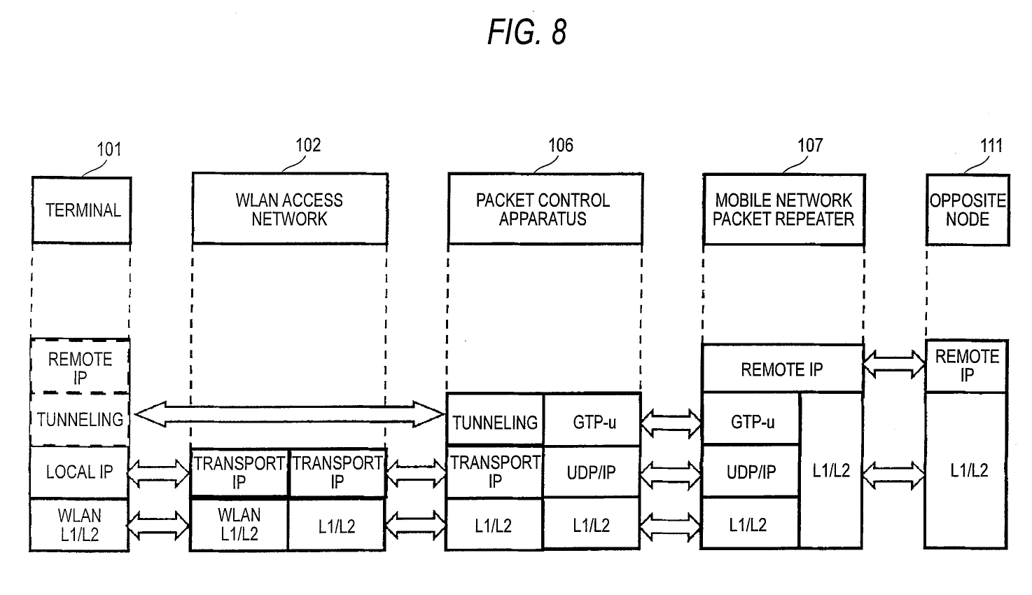

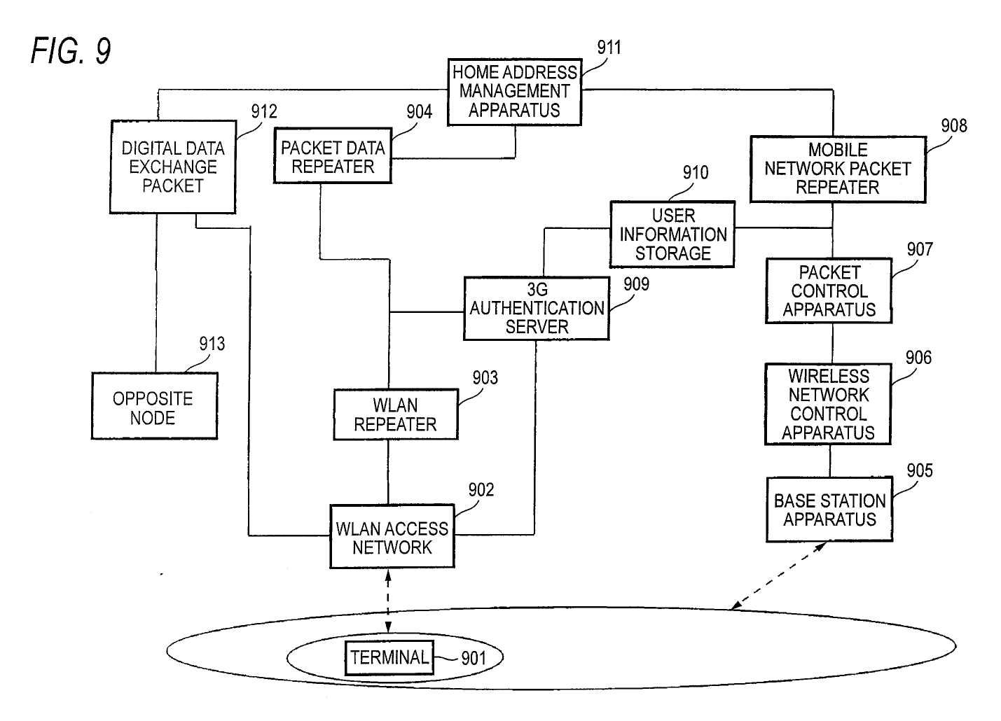

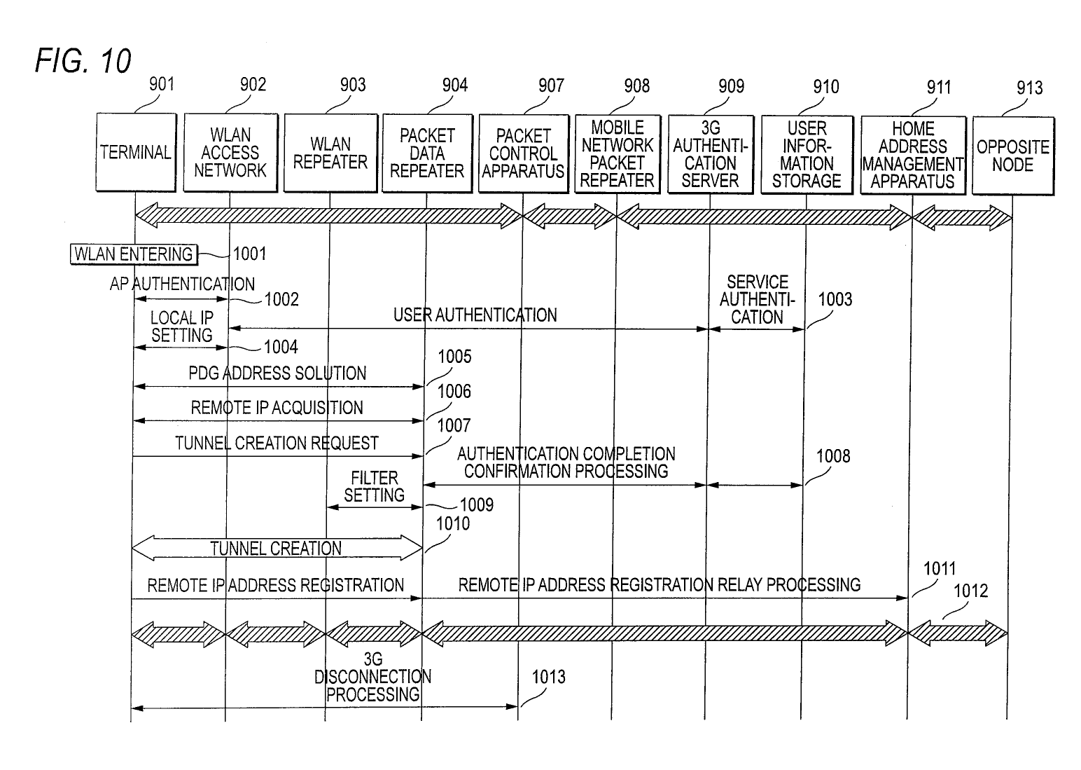

After the filter setting, the tunnel attributes are exchanged between the terminal 101 and the packet control apparatus 106 and a tunnel therebetween is created (408). When the tunnel is created, the WLAN switch management means 204 in the packet control apparatus 106 changes the destination of a packet from the opposite node 111 to the terminal 101 corresponding to the new local IP address with the tunnel created (409). Thus, the packet communications are switched from the mobile communication network to the WLAN network. FIG. 8 shows protocol stacks in the packet communications using the WLAN network at this time.

When connection in the WLAN is thus established (410), the terminal 101 terminates transmission in the mobile communication network used before the terminal enters the WLAN area (411). This processing is performed by issuing 3G termination processing to the packet control apparatus 106.

According to the embodiment of the invention, when the terminal moves across networks based on different access techniques in the interwork system of the mobile communication network and WLAN, the WLAN switch management means 204 in the packet control apparatus 106 can perform authentication processing and connection processing in the WLAN network, so that the processing time in the interwork of the mobile communication network and WLAN can be shortened and the possibility of a break in real time communications of a video conference, video distribution, etc., using the Internet can be decreased.

While the invention has been described in detail with reference to the specific embodiment, it will be obvious to those skilled in the art that various changes and modifications can be made without departing from the spirit and the scope of the invention.

This application is based on Japanese Patent Application (No. 2005-014021) filed on Jan. 21, 2005, which is incorporated herein by reference.

### INDUSTRIAL APPLICABILITY

According to the invention, the address determined by the address determination means is assigned to the terminal determined by making a comparison between the authentication information of the terminal contained in the switch notification and the authentication information contained in the table for managing information concerning terminals that can access the first and second networks and the destination of a packet via the first network is switched to the second network, whereby the time required for address solution can be shortened, so that the switching time from the first network to the second network can be shortened, and the invention is useful for the hand over technology of continuing communications in the interworking system of different types of networks, etc.

1. A packet control apparatus comprising:
an authentication server communication section for receiving a switch notification of a terminal switched from a first network to a second network by conducting communications with an authentication server for performing network authentication processing;
an address determination section for determining an address that can be used in the second network; and
a switch management section for assigning the address determined by said address determination section to the terminal determined by making a comparison between authentication information of the terminal contained in the switch notification and authentication information contained in a table for managing information concerning terminals that can access the first and second networks and switching the destination of a packet via the first network to the second network.

2. The packet control apparatus as claimed in claim 1, wherein upon reception of the switch notification, said switch management section updates information indicating the authentication result of the first network contained in the table to already authenticated.

3. The packet control apparatus as claimed in claim 1, wherein said switch management section manages an IP address of the terminal assigned in the second network according to information indicating an IP address in the second network, contained in the table.

4. The packet control apparatus as claimed in claim 1, wherein said switch management section makes filter setting of a transmission packet via the first network with a gateway based on information of subscription service contained in the switch notification.

5. An authentication server for performing network authentication processing, said authentication server comprising:
a switch notification issuing section for issuing a switch notification of a terminal switched from a first network to a second network; and
a transmitter for transmitting the switch notification to the packet control apparatus as claimed in claim 1.

6. A wireless communication system comprising the packet control apparatus as claimed in claim 1 and the authentication server as claimed in claim 5.

7. A wireless communication system comprising the packet control apparatus as claimed in claim 2 and the authentication server as claimed in claim 5.

8. A wireless communication system comprising the packet control apparatus as claimed in claim 3 and the authentication server as claimed in claim 5.

9. A wireless communication system comprising the packet control apparatus as claimed in claim 4 and the authentication server as claimed in claim 5.
